(19) United States
(12) Patent Application Publication
(10) Pub. No.: US 2022/0291983 A1
(43) Pub. Date: Sep. 15, 2022

(54) ANALYSIS SYSTEM, METHOD OF PRESENTING RESULT OF INSPECTION IN ANALYSIS SYSTEM AND NON-TRANSITORY COMPUTER READABLE MEDIUM STORING PROGRAM

(71) Applicant: SHIMADZU CORPORATION, Kyoto (JP)

(72) Inventor: Shinji SUGIMOTO, Kyoto (JP)

(21) Appl. No.: 17/680,490

(22) Filed: Feb. 25, 2022

(30) Foreign Application Priority Data
Mar. 12, 2021 (JP) 2021-040344

(51) Int. Cl. G06F 11/07

(52) U.S. Cl. CPC G06F 11/079; G06F 11/0769; G06F 11/0772; G06F 11/0781; G06F 11/0775

(57) ABSTRACT

An analysis system includes a recorder that records a point in time at which an event occurs in an analysis system and event contents as a log, an extractor that extracts a related log relating to an error from the log acquired between a last point in time at which the analysis system passes an inspection and a point in time at which the error occurs, when the error occurs in the inspection performed on the analysis system, and a presenter that presents the related log extracted by the extractor to a user.

### BACKGROUND

### Technical Field

The present invention relates to an analysis system, a method of presenting a result of inspection in the analysis system and a non-transitory computer readable medium storing a program.

### Description of Related Art

Various inspections are performed on an analysis system including an analysis device such as a liquid chromatograph in order to confirm whether the system is maintaining an expected performance. In a case in which a result of inspection includes an error, the work for identifying the cause of the error and removing the cause is performed. Further, the analysis system cannot be utilized until the analysis system passes the inspection again. A user is required to analyze the course of events prior to the occurrence of an error and identify the cause of the error using his or her past experience. Although a log that is accumulated in the analysis system can be used, it still requires a lot of experience and effort to find out the cause of an error from all of the logs.

JP 2015-152567 A discloses a chromatograph running state monitoring device that monitors whether a chromatograph is running normally.

### SUMMARY

As described above, a user is required to have a lot of experience to identify the cause of an error in the analysis system. There is also an option of asking a manufacturer for maintenance to solve a program. However, it is problematic in terms of cost and that it requires a lot of time for recovery of the analysis system.

An object of the present invention is to provide an analysis system that can reduce time and effort in identification of a cause of an error based on a result of inspection.

An analysis system according to one aspect of the present invention includes a recorder that records a point in time at which an event occurs in an analysis system and event contents as a log, an extractor that extracts a related log relating to an error from the log acquired between a last point in time at which the analysis system passes an inspection and a point in time at which the error occurs, when the error occurs in the inspection performed on the analysis system, and a presenter that presents the related log extracted by the extractor to a user.

A method of presenting a result of inspection of an analysis system according to another aspect of the present invention includes recording a point in time at which an event occurs in an analysis system and event contents as a log, extracting a related log relating to an error from the log acquired between a last point in time at which the analysis system passes an inspection and a point in time at which the error occurs, when the error occurs in the inspection performed on the analysis system, and presenting the related log extracted by the extractor to a user.

A non-transitory computer readable medium storing a program for presenting a result of inspection of an analysis system according to yet another aspect of the present invention causes a computer to execute the processes of recording a point in time at which an event occurs in an analysis system and event contents as a log, extracting a related log relating to an error from the log acquired between a last point in time at which the analysis system passes an inspection and a point in time at which the error occurs, when the error occurs in the inspection performed on the analysis system, and presenting the related log extracted by the extractor to a user.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is an overview of an analysis system according to the present embodiment;

FIG. 2 is a diagram showing the configuration of a management device according to the present embodiment;

FIG. 3 is a diagram showing label information that associates cause labels with error phenomena;

FIG. 4 is a diagram showing event information that associates events with the cause labels;

FIG. 5 is a diagram showing inspection item information that associates inspection items with the cause labels;

FIG. 6 is a diagram showing a log;

FIG. 7 is a flowchart showing a management method according to the present embodiment; and

FIG. 8 is a diagram showing an inspection result screen displayed in a display unit.

### DETAILED DESCRIPTION

An analysis system, a method of presenting a result of inspection in the analysis system and a program according to embodiments of the present invention will now be described with reference to the attached drawings.

(1) Overall Configuration of Analysis System

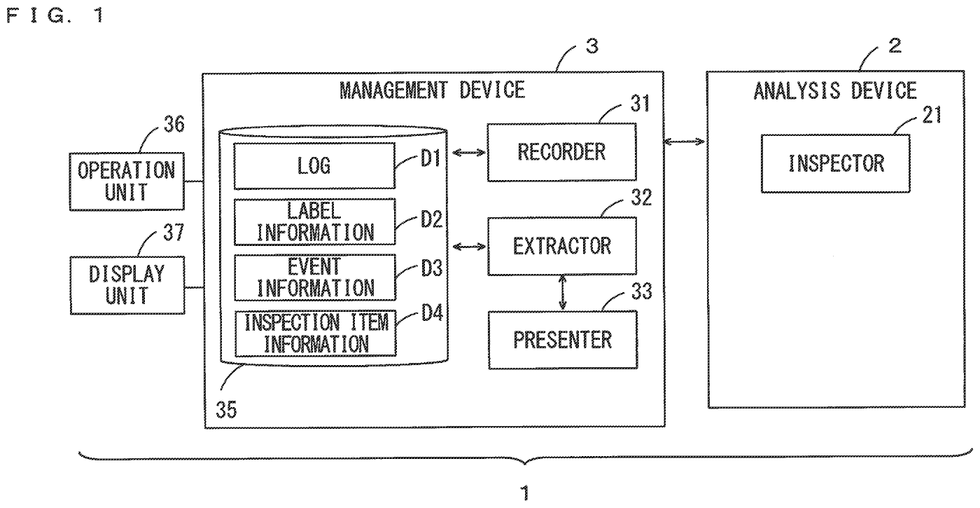

The analysis system 1 according to embodiments of the present invention will be described below in detail with reference to the drawings. FIG. 1 is an overview of the analysis system 1 according to the embodiments of the present invention. As shown in FIG. 1, the analysis system 1 includes an analysis device 2 and a management device 3.

The analysis device 2 is a liquid chromatograph, a gas chromatograph or a mass spectrometer, for example. The management device 3 is a device that controls the analysis device 2. As the management device 3, a personal computer (PC) is used, for example. The management device 3 is connected to the analysis device 2 via a network such as a LAN (Local Area Network). Alternatively, the management device 3 may be directly connected to the analysis device 2 via a communication cable.

The analysis device 2 includes an inspector 21. The inspector 21 inspects whether the analysis device 2 is maintaining an expected performance. That is, the inspector 21 is a function with which the analysis device 2 checks its own condition. In the present embodiment, the inspector 21 performs an inspection called auto-tuning. Auto-tuning is a function of performing an inspection on the analysis device 2 in regard to a plurality of inspection items. A user provides an instruction for performing auto-tuning by operating the management device 3, so that the inspector 21 performs auto-tuning. This can reduce a burden on the user in causing the analysis device 2 to perform individual inspections. For example, the user causes the inspector 21 to perform auto-tuning each time an analysis process is executed in the analysis device 2. Alternatively, the user may cause the inspector 21 to perform individual inspections in regard to the inspection items.

The management device 3 includes a recorder 31, an extractor 32, a presenter 33, a database 35, an operation unit 36 and a display unit 37. The recorder 31 acquires information about an event that has occurred in the analysis device 2 from the analysis device 2 and records a log D1. Each record recorded in the log D1 includes information such as an event occurrence point in time and event contents. Events include behavior of the analysis device 2, and work and setting and so on that are performed on the analysis device 2. Events include activation of the device, stopping of the device, start of an analysis, end of an analysis, replacement of various components such as a column, etc. The recorder 31 stores the log D1 regarding an event that has occurred in the analysis device 2 in the database 35.

In the database 35, label information D2, event information D3 and inspection item information D4 are stored in addition to the log D1. Details of the label information D2, the event information D3 and the inspection item information D4 will be described below.

The extractor 32 extracts a related log in regard to the cause of an error in the inspection of the analysis device 2 from the log D1 saved in the database 35. The presenter 33 displays the related log in the display unit 37 included in the management device 3. The display unit 37 is a liquid crystal display, for example. The operation unit 36 receives a user's operation with respect to the management device 3. The operation unit 36 includes a keyboard and a mouse, for example. The user can provide an instruction for performing an inspection such as auto-tuning to the inspector 21 of the analysis device 2 by operating the operation unit 36. Further, the user can cause the display unit 37 to display information about a result of inspection by operating the operation unit 36.

(2) Configuration of Management Device

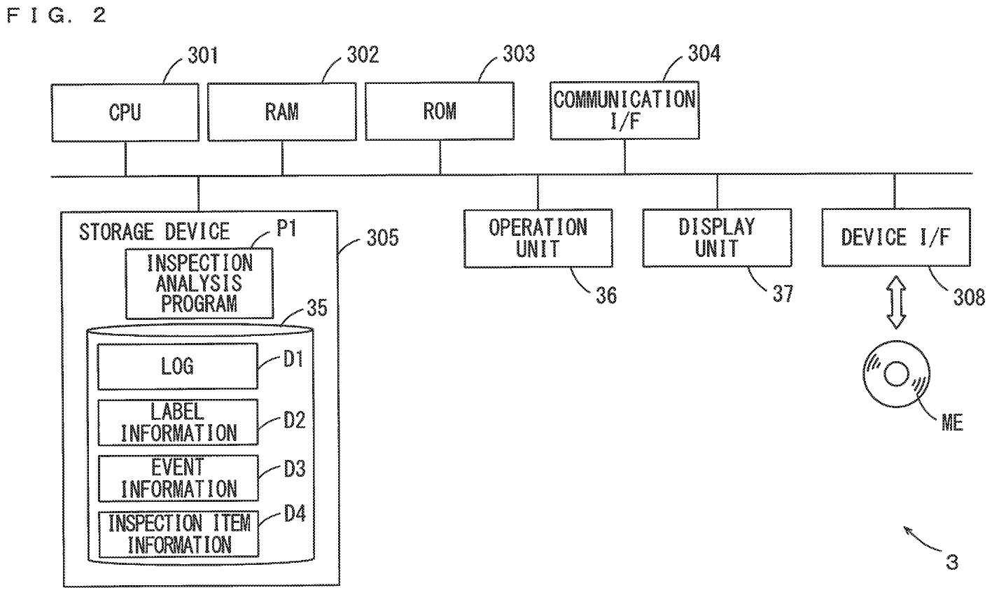

FIG. 2 is a diagram showing the configuration of the management device 3. For example, a personal computer is utilized as the management device 3 as described above. The management device 3 includes a CPU (Central Processing Unit) 301, a RAM (Random Access Memory) 302, a ROM (Read Only Memory) 303, a communication interface 304, a storage device 305, the operation unit 36, the display unit 37 and a device interface 308. The storage device 305 is a hard disc, for example.

The CPU 301 controls the management device 3. The RAM 302 is used as a work area for execution of a program by the CPU 301. The communication interface 304 is an interface that communicates with another computer and another device. The CPU 301 can communicate with a computer or the analysis device 2 connected to the LAN and a computer connected to the Internet via the communication interface 304. The device interface 308 is an interface for accessing a storage medium ME.

In the storage device 305, an inspection analysis program P1 and the database 35 are saved. The inspection analysis program P1 acquires a result of inspection performed by the inspector 21 of the analysis device 2 and provides the information for identifying the cause of an error present in the analysis device 2 to the user. The recorder 31, the extractor 32 and the presenter 33 shown in FIG. 1 are functions that are implemented when the CPU 301 executes the inspection analysis program P1 while utilizing the RAM 302 as a work area.

(3) Contents of Database

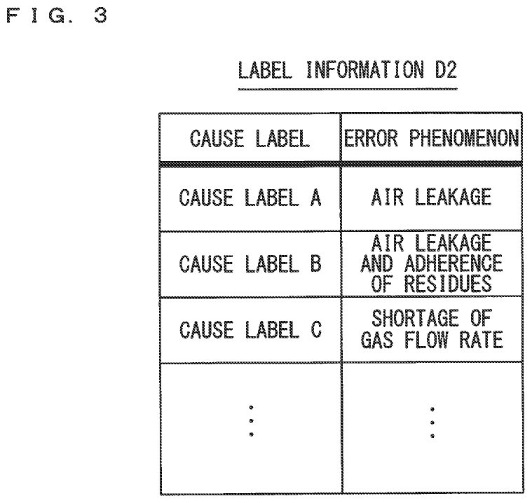

The label information D2, the event information D3 and the inspection item information D4 stored in the database 35 will be described next with reference to FIGS. 3 to 5. FIG. 3 is a diagram showing one example of the label information D2. The label information D2 has a “cause label” field and an “error phenomenon” field. A “cause label” is a label given to an “error phenomenon” that occurs in the analysis device 2. In the example of the diagram, a “cause label A” is given to the “error phenomenon” of “air leakage,” a “cause label B” is given to the “error phenomenon” of “air leakage and adherence of residues” and a “cause label C” is given to the “error phenomenon” of “shortage of gas flow rate.” In this manner, in the label information D2, all of the error phenomena that are detectable by the inspector 21 are registered, and the cause labels are given to all of these error phenomena.

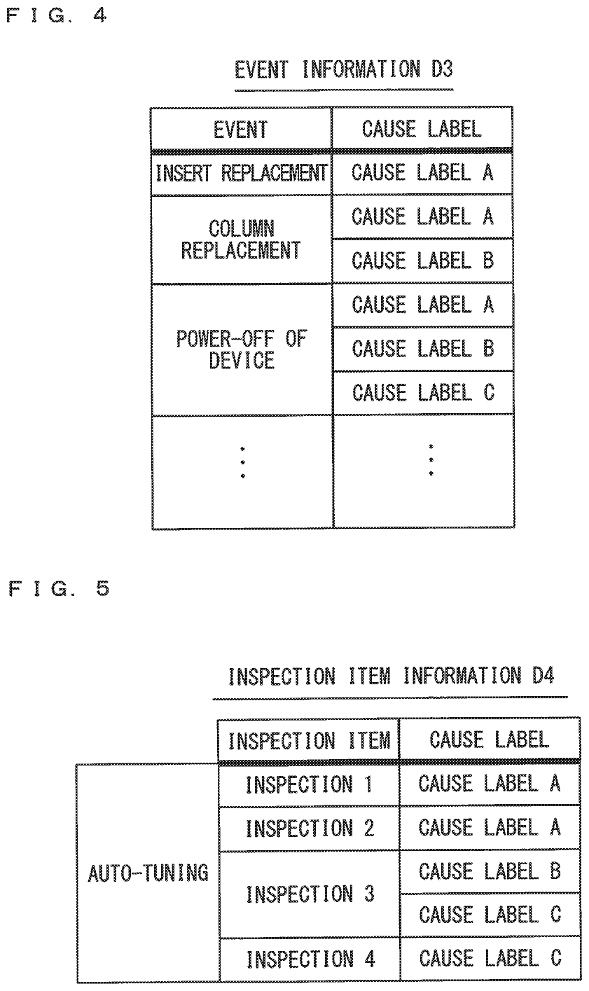

FIG. 4 is a diagram showing one example of the event information D3. The event information D3 has an “event” field and a “cause label” field. As described above, “events” includes behavior of the analysis device 2, and work, setting and so on that are performed on the analysis device 2. A “cause label” is a label given to an “error phenomenon” registered in the label information D2. In the example of the diagram, the “cause label A” is given to the “event” of “insert replacement.” That is, it is registered that “air leakage” registered as the cause label A may occur due to insert replacement. The “cause label A” and the “cause label B” are given to the “event” of “column replacement,” by way of example. That is, it is registered that “air leakage” registered as the cause label A and “air leakage and adherence of residuals” registered as the cause label B may occur due to “column replacement.” The “cause label A,” the “cause label B” and the “cause label C” are given to the “event” of “power-off of device,” by way of example. That is, it is registered that “air leakage” registered as the cause label A, “air leakage and adherence of residuals” registered as the cause label B and “shortage of gas flow rate” registered as the cause label C may be occur due to “power-off of device.”

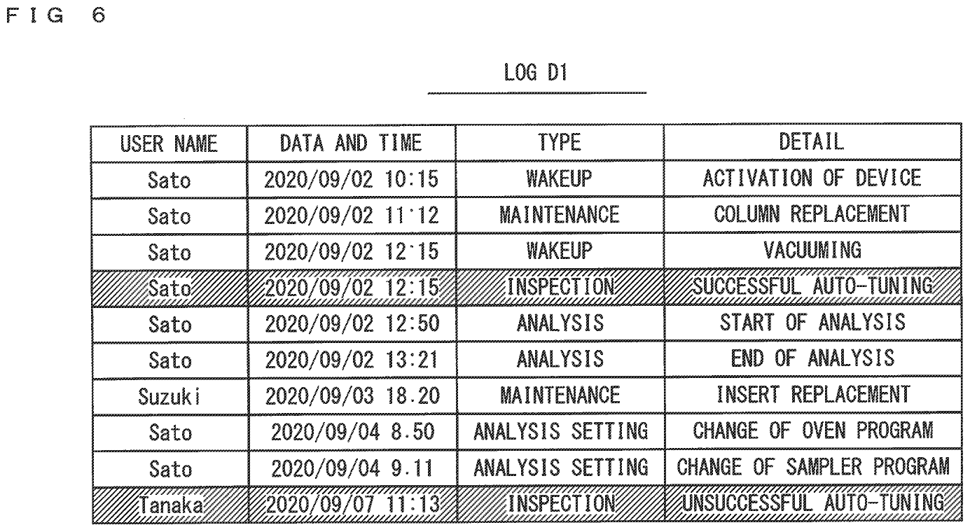

FIG. 5 is a diagram showing one example of the inspection item information D4. The inspection item information D4 has an “inspection item” field and a “cause label” field. The “inspection item” represents a type of inspection performed on the analysis device 2. In the example of FIG. 5, inspections 1 to 4 that are performed automatically when auto-tuning is performed are shown. A “cause label” is a label given to an “error phenomenon” registered in the label information D2. In the example of diagram, it is registered that, in a case in which an error occurs when the “inspection 1” is performed, “air leakage” indicated by the “cause label A” may be present. It is similarly registered that, in a case in which an error occurs when the “inspection 2” is performed, “air leakage” indicated by the “cause label A” may be present. It is registered that, in a case in which an error occurs when the “inspection 3” is performed, “air leakage and adherence of residuals” indicated by the “cause label B” and “shortage of gas flow rate” indicated by the “cause label C” may be present. It is registered that, in a case in which an error occurs when the “inspection 4” is performed, “shortage of gas flow rate” indicated by the “cause label C” may be present.

The log D1 stored in the database 35 will be described next with reference to FIG. 6. FIG. 6 is a diagram showing one example of the log D1 stored in the database 35. When any behavior registered in the event information D3 or any work or setting registered in the event information D3 is performed on the analysis device 2, the recorder 31 records a record in regard to an event that has occurred in the log D1. As shown in FIG. 6, one record in the log D1 has four fields of “user name,” “date and time,” “type” and “detail.” In the “user name,” the name of a user who has caused an event to occur is recorded. In the “date and time,” an event occurrence point in time is recorded. In the “type,” the type of an event is recorded. In the “detail,” a detail of an event is recorded. In the “detail” field of the log D1, an event registered in the event information D3 is recorded.

For example, in the top record of FIG. 6, it is registered that a user “Sato” activated the analysis device 2 (wake-up) at 10:15 on Sep. 2, 2020. In the second record, it is recorded that the user “Sato” replaced a column of the analysis device 2 (maintenance) at 11:12 on Sep. 2, 2020. The recorder 31 receives a notification of an event that has occurred from a controller (not shown) of the analysis device 2. The recorder 31 records a corresponding record in the log D1 in response to receiving a notification of an event.

(4) Method of Presenting Result of Inspection

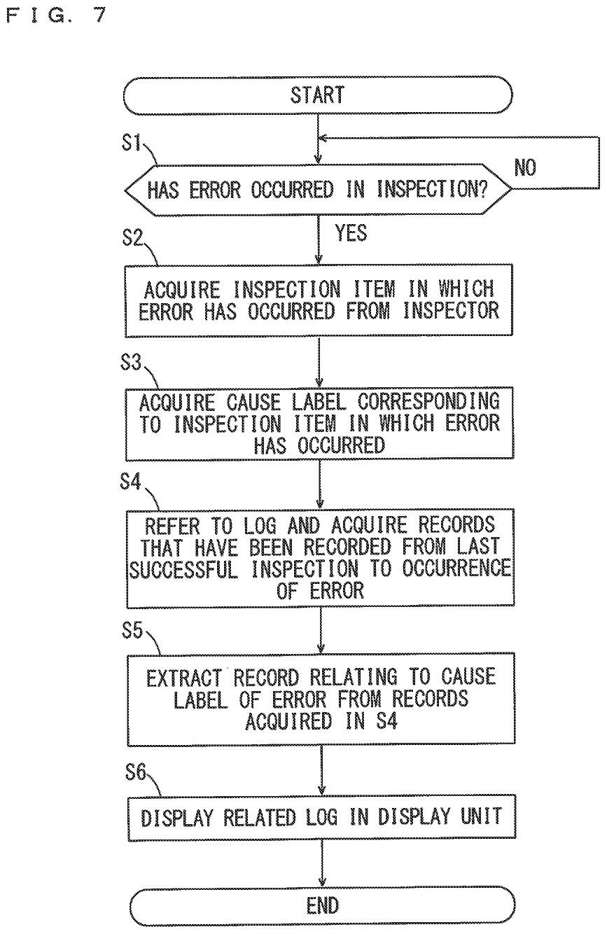

A method of presenting a result of inspection according to the present embodiment will be described next with reference to FIG. 7. FIG. 7 is a flowchart showing the method of presenting a result of inspection. In the step S1, the extractor 32 of the management device 3 determines whether an error has occurred in the inspection of the analysis device 2. The extractor 32 determines whether an error has occurred in the inspection by receiving a notification of a result of inspection from the inspector 21 of the analysis device 2. Alternatively, the extractor 32 may determine presence or absence of an error in the inspection by referring to the log D1 recorded by the recorder 31.

When determining that an error has occurred in the inspection of the analysis device 2, the extractor 32 acquires an inspection item in which the error has occurred from the inspector 21 in the step S2. For example, in the example shown in FIG. 5, an inspection is performed in regard to the four inspection items of the inspections 1 to 4 by auto-tuning. The inspector 21 notifies the extractor 32 of whether an error has occurred in regard to any of the inspection items of the inspections 1 to 4. Subsequently, in the step S3, the extractor 32 refers to the inspection item information D4 to acquire a cause label corresponding to an inspection item in which an error has occurred.

Next, in the step S4, the extractor 32 refers to the log D1 and acquires records that have been recorded from a last point in time at which an inspection is successful to an error occurrence point in time in this inspection. According to the example shown in FIG. 6, auto-tuning performed by the user “Sato” at 12:15 on Sep. 2, 2020 is successful. Then, auto-tuning performed by a user “Tanaka” at 11:13 on Sep. 7, 2020 is unsuccessful. Therefore, the extractor 32 acquires 7 records that have been recorded in the log D1 from 12:15 on Sep. 2, 2020 to 11:13 on Sep. 7, 2020.

Subsequently, in the step S5, the extractor 32 extracts a record relating to a cause label of an error from the records acquired in the step S4. An error has occurred in the inspection 2 in the auto-tuning shown in FIG. 5, by way of example. In this case, the extractor 32 identifies the “cause label A” as a cause of error in accordance with the inspection item information D4. Thus, in the step S3, the extractor 32 acquires the “cause label A” as a cause label. The extractor 32 determines whether an event associated with the “cause label A” is present in the records acquired in the step S4. The extractor 32 refers to the records acquired in the step S4 and the event information D3 shown in FIG. 4, and determines that the “cause label A” is associated with “insert replacement” performed at 18:20 on Sep. 3, 2020. Thus, the extractor 32 extracts a record relating to the “insert replacement” as a related log.

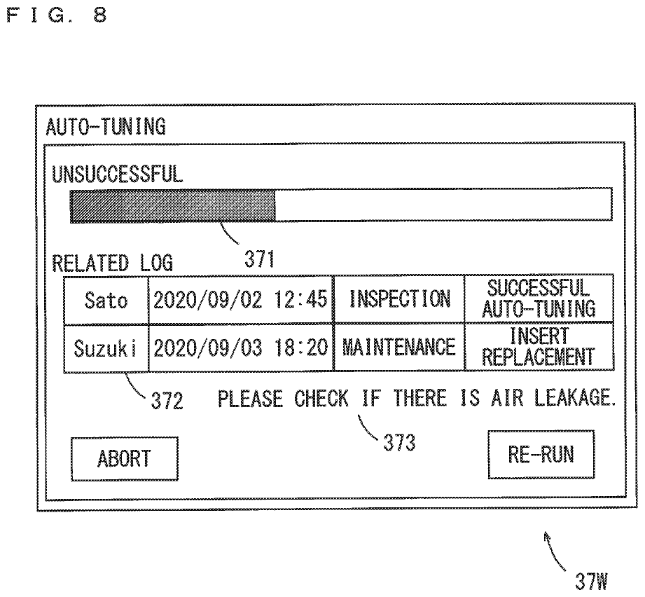

Then, in the step S6, the presenter 33 displays the related log extracted in the step S5 in the display unit 37. FIG. 8 shows an inspection result screen 37W displayed in the display unit 37. In the inspection result screen 37W, a progress bar 371 of auto-tuning is displayed in an upper field. The progress bar 371 stops halfway and indicates that auto-tuning has failed. Further, the records extracted in the step S5 are displayed as related logs 372. That is, the record relating to the “insert replacement” performed at 18:20 on Sep. 3, 2020 is displayed as the related log 372. Further, in this example, successful auto-tuning performed at 12:45 on Sep. 2, 2020 is displayed in the related log 372 as reference information. By referring to the inspection result screen 37W, the user can recognize that auto-tuning is previously successful on September 2, and that the “insert replacement” performed on September 3 may have caused the error.

Further, a handling message field 373 is provided in a lower field of the inspection result screen 37W. In this example, a message “Please check if there is air leakage” is displayed in the handling message field 373. As shown in FIG. 4, the “insert replacement” is associated with the “cause label A.” As shown in FIG. 3, the “cause label A” is associated with the “air leakage” as the error phenomenon. The presenter 33 holds messages indicating handling methods corresponding to cause labels, and this message is displayed in the handling message field 373. Thus, the user can be informed of an effective handling method for recovery of the analysis system 1.

As described above, when an error occurs in the inspection performed on the analysis system 1, the analysis system 1 of the present embodiment extracts a related log relating to the error from the log D1 that has been acquired from a point in time at which inspection is previously successful to an error occurrence point in time. Then, the presenter 33 displays the related log extracted by the extractor 32 in the inspection result screen 37W. Thus, the user can confirm an event that may have caused the error that has occurred in the analysis system 1 in the inspection result screen 37W. Further, because the error handling method is presented in the handling message field 373 of the inspection result screen 37W, the user can be informed of the effective error handling method. In this manner, even in a case in which the user does not have advanced knowledge about the system, the analysis system 1 of the present embodiment facilitates identification of the cause of an error that has occurred in the analysis system 1. This saves time and labor required for recovery from an error that has occurred in the analysis system 1.

(5) Other Embodiments

In the above-mentioned embodiment, the presenter 33 displays a related log in the display unit 37 included in the management device 3. In another embodiment, the presenter 33 may notify a user of a message such as an email mentioning a related log, for example. Alternatively, the presenter 33 may print out a related log.

In the above-mentioned embodiment, the management device 3 is connected to the analysis device 2 via a network such as the LAN, by way of example. In another embodiment, the management device 3 may be incorporated in the analysis device 2. For example, a system controller included in the analysis device 2 may include the function of the management device 3 in the above-mentioned embodiment.

In the above-mentioned embodiment, the inspection analysis program P1 is stored in the storage device 305, by way of example. The inspection analysis program P1 may be provided in the form of being stored in the storage medium ME shown in FIG. 2. The CPU 301 can read the inspection analysis program P1 stored in the storage medium ME via the device interface 308. The CPU 301 may directly activate the inspection analysis program P1 stored in the storage medium ME or install the inspection analysis program P1 in the storage device 305 or the ROM 303 of the management device 3. As the storage medium ME, a CD-ROM, a DVD or a USB memory can be utilized. Further, the inspection analysis program P1 may be downloaded from a server on the network via the communication interface 304. The downloaded inspection analysis program P1 can be saved in the storage device 305 or the ROM 303.

(6) Correspondences between Constituent Elements in Claims and Parts in Preferred Embodiments

In the following paragraphs, non-limiting examples of correspondences between various elements recited in the claims below and those described above with respect to various preferred embodiments of the present disclosure are explained. In the above-mentioned embodiment, the information recorded in the “date and time” field of the log D1 is an example of an event occurrence point in time, and the information recorded in the “detail” field of the log D1 is an example of event contents. Further, in the above-mentioned embodiment, the inspections 1 to 4 included in auto-tuning are examples of a plurality of inspection items.

As each of constituent elements recited in the claims, various other elements having configurations or functions described in the claims can be also used.

(7) Aspects

It is understood by those skilled in the art that the plurality of above-mentioned illustrative embodiments are specific examples of the below-mentioned aspects.

(Item 1) An analysis system according to one aspect may include a recorder that records a point in time at which an event occurs in an analysis system and event contents as a log, an extractor that extracts a related log relating to an error from the log acquired between a last point in time at which the analysis system passes an inspection and a point in time at which the error occurs, when the error occurs in the inspection performed on the analysis system; and a presenter that presents the related log extracted by the extractor to a user.

An analysis system that can reduce time and effort for identifying the cause of an error based on a result of inspection can be provided.

(Item 2) The analysis system according to item 1, wherein the presenter may further present an error handling method to a user.

A user can be informed of an error handling method.

(Item 3) The analysis system according to item 1 or 2, wherein the inspection may include a plurality of inspection items, the analysis system may identify an inspection item in which an error occurs among the plurality of inspection items, and the extractor may identify the related log to be extracted in accordance with an identified inspection item.

A related log to be extracted is identified in accordance with an inspection item in which an error has occurred.

(Item 4) The analysis system according to item 3, wherein an occurrable error phenomenon may be associated with each inspection item, and an occurrable error phenomenon is associated with each event, and the extractor may identify the error phenomenon based on an inspection item in which the error occurs and may identify the related log based on the identified error phenomenon.

Because each inspection item and an event are associated with each other by an error phenomenon, a related log is extracted by identification of an inspection item in which an error has occurred.

(Item 5) The analysis system according to any one of items 1 to 4, wherein the presenter may further present last date and time when the analysis system passes an inspection to a user.

The user can be informed of an occurrence time of the cause of an error in the analysis system.

(Item 6) A method of presenting a result of inspection of an analysis system according to another aspect may include recording a point in time at which an event occurs in an analysis system and event contents as a log, extracting a related log relating to an error from the log acquired between a last point in time at which the analysis system passes an inspection and a point in time at which the error occurs, when the error occurs in the inspection performed on the analysis system, and presenting the related log extracted by the extractor to a user.

An analysis system that can reduce time and effort for identifying the cause of an error based on a result of inspection can be provided.

(Item 7) A non-transitory computer readable medium storing a program for presenting a result of inspection of an analysis system according to another aspect may cause a computer to execute the processes of recording a point in time at which an event occurs in an analysis system and event contents as a log, extracting a related log relating to an error from the log acquired between a last point in time at which the analysis system passes an inspection and a point in time at which the error occurs, when the error occurs in the inspection performed on the analysis system; and presenting the related log extracted by the extractor to a user.

An analysis system that can reduce time and effort for identifying the cause of an error based on a result of inspection can be provided.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. An analysis system comprising:
a recorder that records a point in time at which an event occurs in an analysis system and event contents as a log;
an extractor that extracts a related log relating to an error from the log acquired between a last point in time at which the analysis system passes an inspection and a point in time at which the error occurs, when the error occurs in the inspection performed on the analysis system; and
a presenter that presents the related log extracted by the extractor to a user.

2. The analysis system according to claim 1, wherein
the presenter further presents an error handling method to a user.

3. The analysis system according to claim 1, wherein
the inspection includes a plurality of inspection items,
the analysis system identifies an inspection item in which an error occurs among the plurality of inspection items, and
the extractor identifies the related log to be extracted in accordance with an identified inspection item.

4. The analysis system according to claim 3, wherein
an occurrable error phenomenon is associated with each inspection item, and an occurrable error phenomenon is associated with each event, and
the extractor identifies the error phenomenon based on an inspection item in which the error occurs and identifies the related log based on the identified error phenomenon.

5. The analysis system according to claim 1, wherein
the presenter further presents last date and time when the analysis system passes an inspection to a user.

6. A method of presenting a result of inspection of an analysis system including:
recording a point in time at which an event occurs in an analysis system and event contents as a log;
extracting a related log relating to an error from the log acquired between a last point in time at which the analysis system passes an inspection and a point in time at which the error occurs, when the error occurs in the inspection performed on the analysis system; and
presenting the related log extracted by the extractor to a user.

7. A non-transitory computer readable medium storing a program for presenting a result of inspection of an analysis system, causing a computer to execute the processes of:
recording a point in time at which an event occurs in an analysis system and event contents as a log;
extracting a related log relating to an error from the log acquired between a last point in time at which the analysis system passes an inspection and a point in time at which the error occurs, when the error occurs in the inspection performed on the analysis system; and
presenting the related log extracted by the extractor to a user.
